(19) United States
(12) Patent Application Publication
(10) Pub. No.: US 2024/0390109 A1
(43) Pub. Date: Nov. 28, 2024

(54) Method for manufacturing a customized corrective dental aligner for the simultaneous treatment of a patient's functional orthodontic and orthopedic problems

(71) Applicant: TRIOSMILE, BORDEAUX (FR)

(72) Inventors: Antoine TRILLAUD, BORDEAUX (FR); Joël GIPCH, PARIS (FR)

(21) Appl. No.: 18/651,919

(22) Filed: May 1, 2024

(30) Foreign Application Priority Data
May 5, 2023 (FR) FR2304529

(51) Int. Cl. A61C 7/00; A61C 7/08; A61C 13/34; B33Y 50/00; B33Y 80/00

(52) U.S. Cl. CPC A61C 7/002; A61C 7/08; A61C 13/34; B33Y 50/00; B33Y 80/00

(57) ABSTRACT

A method for manufacturing a personalized corrective dental aligner for correcting a patient's oral system, the method being implemented by a computer system, characterized in that it comprises the following steps:
(1) receiving an initial 3D model of the patient's oral system;
(2) determining functional, orthopedic and orthodontic diagnostic factors;
(3) determining corrective parameters based on these factors;
(4) generating a corrective 3D model from the initial model, corrective parameters and diagnostic factors;
(5) generating at least one 3D model of a customized corrective aligner to transform the initial model into a corrective model;
(6) manufacturing a corrective aligner from a 3D model of a customized dental aligner.

### TECHNICAL FIELD

The invention relates to the technical field of orthodontics and dentofacial orthopedics, and in particular to the design and manufacture of customized corrective dental aligners.

The subject of the invention is a computer-implemented method for manufacturing a customized, age-appropriate dental aligner, designed based on joint functional, orthodontic and orthopedic analyses of the patient.

The invention also relates to a corrective dental aligner obtained by the aforementioned manufacturing method.

### PRIOR ART

At present, corrective devices in orthodontics and dentofacial orthopedics are mainly based on the use of aligners, with or without add-on devices, or customized rigid removable or fixed appliances that can be combined with standard soft aligners. Other options include fixed or mobile orthodontic and orthopedic appliances such as intermaxillary elastics, palatal splints, orthodontic wires, temporary anchoring screws and braces. These standardized devices require manual customization by the practitioner to adapt the device to the patient's specific requirements and individual maxillofacial and oral morphology.

In the particular case of removable braces, the dental professional manufactures them in a quasi-artisanal way, assembling different elements on a base typically produced in resin and reworked to adapt it to the patient's anatomy, so as to finally obtain the corrective dental appliance customized for the patient.

This process is extremely time-consuming and laborious, and usually requires regular intervention by the dental professional, who has to readjust and check the device regularly during treatment. What is more, if the corrective device is lost, the dental professional has to make a new one, with the additional manufacturing costs associated with replacing the corrective device.

Because of the technical nature and time required to produce such corrective appliances, the selling price can be relatively high, making the product unaffordable for the patient. In addition, a major drawback is that patients have to wear these devices continuously for long periods. Additionally, current orthodontic appliances do not take into account patients' full functional, orthopedic and orthodontic needs, which can lead to unsatisfactory results, requiring further treatment or leading to the irreparable impossibility of achieving a successful corrective result in patients, a phenomenon commonly referred to as “loss of opportunity.”

A major problem with existing corrective appliances is that they are not designed to deal comprehensively with mixed functional, orthopedic and orthodontic problems. The main reason for this is the difficulty of integrating the results of functional, orthopedic and orthodontic analyses of the patient's anatomy into a single medium capable of defining progressive and effective therapeutic strategies.

At present, there is no single solution that can simultaneously correct all dental, bone, muscle and functional dysfunctions, especially when it comes to guiding tooth growth and adjusting jaw position. This lack of a device that fully meets the patient's needs very often leads to unsatisfactory or incomplete results, involving prolonged treatment times and/or recurrence of orthodontic problems and/or loss of opportunity.

Additionally, generic dental aligners are standardized, and fixed orthodontic appliances can cause significant discomfort for patients, not least because of the pressure exerted on the teeth and gums, as well as the difficulties encountered in ensuring proper oral hygiene. The cleaning and maintenance of these devices can be complex, thereby increasing the risk of infection or dental complications.

Today, there is no automated manufacturing method for a corrective dental aligner that simultaneously integrates, right from the design stage, the corrective elements required according to the patient's needs and established on the joint basis of functional, orthodontic and orthopedic analyses of said patient's anatomical structures. Because of the complexity and diversity of individual patient needs in dentofacial treatment, current devices are not designed to address the specific problems of the whole patient. Thus, in the absence of a solution that addresses all these drawbacks, practitioners are forced to use several devices or techniques to treat the same patient, which can increase treatment time and cost. In addition, the use of multiple devices to treat different patient problems can lead to complications and additional costs, as devices may interact in unexpected ways or may not be perfectly compatible with one another.

Additionally, the failure of today's appliances to fully integrate functional, orthodontic and orthopedic aspects can lead to unsatisfactory results, as they fail to take into account all of the patient's needs. This can lead to problems of recurrence, where orthodontic or orthopedic problems reappear after treatment has been completed, necessitating further intervention or loss of opportunity.

There is therefore a need for a manufacturing method for a customized corrective dental aligner, adapted to the patient's morphology and addressing all the patient's functional, orthopedic and orthodontic issues, thus optimizing the effectiveness and quality of the corrective dental aligner while reducing potential complications and improving the overall patient experience.

The invention therefore takes place in this context and aims to solve all of the aforementioned drawbacks. Thus, the invention seeks to propose a method for manufacturing a customized corrective dental aligner for a patient, said aligner being designed from a 3D model defined so as to jointly integrate the results of a set of functional, orthodontic and orthopedic analyses of said patient's oral system according to their age and so that the aligner simultaneously corrects the patient's problems on the functional, orthopedic and orthodontic aspects.

The invention relates to a method for manufacturing a personalized corrective dental aligner for correcting a patient's oral system, the method being implemented by a computer system, characterized in that it comprises the following steps:
a step wherein the computer system receives at least one 3D model, known as the initial model, of the patient's oral system;
a step for determining functional, orthopedic and orthodontic diagnostic factors of the patient's oral system;
a step of determining a set of corrective parameters of the patient's oral system from said diagnostic factors;
a step of generating a 3D model, known as a corrective model, from the initial model, said corrective parameters and said diagnostic factors;
a step of generating at least one 3D model of a customized corrective aligner, enabling the initial model to be transformed into the corrective model;
a step of manufacturing a corrective aligner from said 3D model of a customized dental aligner.

In one embodiment of the invention, the computer system comprises a computing unit, a storage memory and a digital terminal, said digital terminal enabling said computing unit to be controlled by means of a graphical interface of said digital terminal and said storage memory to be accessed so as to be able to access, transmit and modify its content.

Advantageously, said storage memory being able to store a plurality of 2D and/or 3D images of one or more anatomical parts of a patient, in particular of said patient's oral system, in particular such as panoramic radiographs, intra-oral radiographs, intra- and extra-oral photographs.

In one embodiment of the invention, the computer system is an on-board computer system, notably in the form of a digital tablet or computer, capable of receiving and transmitting data by means of a wired and/or wireless and/or satellite communication network.

In an alternative embodiment of the invention, said digital terminal of the computer system is a remote digital terminal, capable of communicating and exchanging data with the computing unit and with the storage memory.

Advantageously, the computing unit is able to execute a plurality of algorithms for rendering, modifying and visualizing 3D digital models, in particular anatomical digital models and digital models of corrective dental aligners.

Also advantageously, said computing unit is able to execute a plurality of algorithms for analyzing, managing and processing 2D and/or 3D images and/or a combination of 2D and 3D images.

If desired, the computer system can comprise a second remote storage memory, accessible via a communications network, said second storage memory being capable of storing a plurality of 2D and/or 3D images of one or more anatomical parts of a patient, in particular of said patient's oral system.

Advantageously, the computer system comprises a graphic interface for displaying 2D and/or 3D images, as well as for rendering a 3D model of the patient's dentofacial anatomy, in particular the patient's oral system and/or a 3D model of a dental aligner.

If desired, said graphical interface can be a touch-sensitive graphical interface and said computer system can be fully embedded on a digital tablet.

Advantageously, said graphical interface can be designed to display content intended to be viewed using 3D glasses.

Even more advantageously, said graphical interface can be designed to display graphical content using a virtual reality headset, in particular compatible with 3D volumetric visualization effects.

Advantageously, the step of determining functional, orthopedic and orthodontic diagnostic factors of the patient's oral system makes it possible to establish a comprehensive assessment of the patient's clinical situation, in particular taking into account the patient's age and stage of growth, and to establish the dependencies between the various diagnostic factors.

Depending on the patient's age, treatment capabilities may be more or less limited. The personalized corrective aligner treatment incorporates this information right from the design stage, enabling growth guidance to be adapted to the different phases of dental and bone development, particularly with regard to the eruption of permanent teeth and changes in the facial skeleton. Owing to this customized approach, the aligner offers a more effective treatment tailored to the evolving needs of the patient throughout their growth. This ability to adapt to different developmental stages means better results in terms of dental alignment and correction of orthopedic and functional problems.

Preferably, the estimation of functional, orthopedic and orthodontic diagnostic factors is performed automatically by the computer system's computing unit. Said computing unit uses specific algorithms to analyze data collected from the patient's 2D and/or 3D dentofacial images, as well as the results of functional tests established by a healthcare professional or by direct analysis of a patient video. Using this data, the computing unit is able to accurately estimate the patient's specific dental treatment needs, and to generate a 3D model of the customized corrective aligner that takes these needs into account.

Additionally, the use of a computing unit to estimate diagnostic factors offers several advantages over manual assessment. Firstly, the computing unit is able to process large amounts of data in a minimal amount of time, enabling faster, more precise design of the corrective aligner. Additionally, the computing unit is able to perform complex analyses to determine the patient's specific dental treatment needs, and to generate a 3D model that integrates all these needs in a coherent and efficient way. Finally, the use of a computing unit for estimating diagnostic factors standardizes the method of designing the corrective aligner, ensuring consistent quality and accuracy for every patient treated.

In one embodiment of the invention, the step of determining functional diagnostic factors is performed automatically by the computing unit based on videos of the patient's anatomy.

Functional diagnostic factors include the patient's lingual positions or postures, ventilation, mastication, swallowing, speech or phonation and salivation, orofacial muscle tone, labial closure capacity, also known as labial competence, coordination of tongue movements, presence of labiolingual malpositions, presence of joint and/or muscle pain, presence of tissue and musculoskeletal malformations.

Advantageously, the determination of functional diagnostic factors can be based in particular on the volume of the aeropharyngeal corridor, the lingual position within the oral cavity, the relative position of the hyoid bone, the presence of lordosis or kyphosis of the spinal column, the volume of the tonsils and adenoids, the presence of a deviated nasal septum, the volume of the frontal or maxillary sinuses and the quantity of mastoid cells present.

Preferably, functional diagnostic factors such as the patient's lingual positions or postures, ventilation, mastication, swallowing, speech or phonation and salivation can be measured using specific functional tests. For example, to assess mastication, the patient may be asked to chew different foods of different textures and consistencies, while to assess swallowing, the patient may be asked to drink or swallow different quantities of water or food. Ventilation can be assessed by means of patient breathing exercises.

To measure these functional diagnostic factors automatically, the computing unit uses specific algorithms to analyze the results of functional tests recorded using equipment such as pressure sensors, cameras, in particular high-speed cameras, spirometers, electrodes and microphones. Using this data, the computing unit is able to accurately estimate jaw function and functional problems, such as disorders of lingual posture, ventilation, mastication, swallowing, speech or salivation.

According to one example, the step of determining functional diagnostic factors may comprise a sub-step of acquiring a video of the patient by means of a camera, a sub-step of facial recognition of the patient in said video, a sub-step of detecting predetermined facial landmarks in the patient's face, in particular located at the jaw, and a classification of the movements of said facial landmarks to determine said functional diagnostic factors, in particular during an event of the ventilation, mastication, swallowing, phonation or salivation type. These various recognition, detection and classification steps can be implemented by one or more machine learning algorithms, such as a convolutional neural network (CNN).

Alternatively or cumulatively, the step of determining functional diagnostic factors may comprise a step of acquiring a lingual ultrasound signal implemented by a lingual ultrasound system, in particular an augmented ultrasound system, equipped with an ultrasound probe; and/or a step of acquiring an electromyogram, or EMG, signal implemented by a surface electromyography system equipped with one or more electrodes; and/or a step of acquiring a signal by an electropalatography system equipped with one or more electrodes. These different techniques can also be used to obtain signals reflecting disorders of lingual posture, ventilation, mastication, swallowing, phonation or salivation, which can then be processed by an algorithm to determine said functional diagnostic factors.

Additionally, the computing unit can also analyze data from a medical imaging system, such as 2D or 3D X-ray images or CT images or cephalometric images from the side or front, or even photographs of the patient from the front or side, to assess the bone structure and soft tissues of the jaw and skull, enabling functional abnormalities and disorders of the jaw to be detected. By combining these different analyses, the computing unit is able to carry out a complete and precise assessment of the patient's functional diagnostic factors.

Orthopedic diagnostic factors include the geometric and structural relationships between the upper and lower dental arches, particularly with respect to the base of the skull,, coordination of jaw movements,, resting position of the mandible, presence of skeletal imbalances.

Advantageously, the determination of orthopedic diagnostic factors can be based, in particular, on a plurality of criteria including the orientation and inclination of the palatal plane and the maxillary plane in the transverse direction, notably in relation to a reference plane that can be attached to the base of the skull, an assembly according to Ballard classes, measurements of the deviation of the mandible and/or maxilla from the midline, of the mandibular angles, of the relative position of the mandible, of the position and orientation of the occlusal plane relative to a reference plane, presence of endognathia or exognathia.

Orthodontic diagnostic factors include tooth location and alignment, tooth inclination and rotation, interdental space size, the presence of crowding or overlapping teeth, the presence of dental arch contractions or dental arch expansions, missing teeth, occlusal balance and anomalies in tooth shape and size.

Advantageously, the determination of orthodontic diagnostic factors may be based, in particular, on tooth alignment, presence of diastemas, measurement of dental crowding, measurement of dental rotations, measurement of overhang and/or overbite, analysis of Spee's curve, measurement of dental arch width, evaluation of sagittal relationships between arches, Angle classes, detection of possible transverse problems and evaluation of incisor inclination.

In one embodiment, orthopedic diagnostic factors and/or orthodontic diagnostic factors may be determined by analysis of an image or video, which may be from a medical imaging system or camera, showing the patient's skull from the front and/or side, or showing the patient's face or showing the inside of the patient's mouth.

If required, the determination of orthopedic and/or orthodontic diagnostic factors may comprise a step of detecting predetermined facial, cranial and/or dental reference points, and a step of measuring geometric characteristics such as distances between pairs of given reference points, such as nose-chin height, and/or angles between lines defined by pairs of given reference points, such as a smile line or tooth inclination, and/or distance ratios, notably intra-arch or inter-arch. These characteristic measurements can then be processed by an algorithm to determine said orthopedic and/or orthodontic diagnostic factors. These various detection and measurement steps can be implemented by one or more machine learning algorithms, such as a convolutional neural network (CNN).

In an alternative or cumulative embodiment of the invention, the step of determining orthodontic factors in particular comprises taking into account the patient's dental evolution, as well as the effects of increased gum volume due to the pericoronary sacs associated with said dental evolution.

Advantageously, this approach makes it possible to design an aligner that takes into account the emergence of new teeth and possible increases in gum volume. In this way, the aligner is designed to leave sufficient space in a recess provided for a new tooth, while taking into account changes in gum volume. This anticipation of future needs ensures better adaptation of the aligner to the patient's dental changes, thus improving the efficiency and comfort of orthodontic treatment.

If desired, the computer system used to design the customized corrective aligner is also able to carry out additional analyses, over and above the automatic analyses performed by the computing unit. These additional analyses can be performed by a dental professional, such as an orthodontist or specialist dentist.

For example, a dental professional can perform an analysis of plaque, gingivitis and possible cavities to determine the patient's level of oral health. They can also assess the function and relationship between the upper and lower jaws, to complement the patient's specific needs for orthopedic, orthodontic and functional correction.

Preferably, said step for determining functional, orthopedic and orthodontic diagnostic factors of the patient's oral system comprises:
i. determining functional diagnostic factors relating to the patient's lingual postures, ventilation, mastication, swallowing, speech and salivation, orofacial muscle tone, labial competence, coordination of tongue movements, presence of labiolingual malpositions, presence of joint and/or muscle pain, and presence of tissue and musculoskeletal malformations;
ii. determining orthopedic diagnostic factors relative to the geometric and structural relationships between the upper and lower dental arches, the coordination of jaw movements, the resting position of the mandible and the presence of skeletal imbalances;
iii. determining orthodontic diagnostic factors relative to tooth location and alignment, tooth inclination and rotation, interdental space size, the presence of crowding or overlapping teeth, the presence of dental arch contractions or dental arch expansions, missing teeth, occlusal balance and the presence of anomalies in tooth shape and size.

Once these additional analyses have been carried out, the results can be fed into the computer system to further refine the design of the customized corrective aligner. In this way, the computer system offers a complete and flexible solution for designing the corrective aligner, which can be adapted to the specific needs of each patient according to their functional, orthopedic and orthodontic diagnostic factors.

Advantageously, the step of determining a set of corrective parameters for the patient's oral system based on the diagnostic factors determined makes it possible to address all the patient's functional, orthopedic and orthodontic problems at the same time.

If desired, each corrective parameter can be given a numerical index indicating the time at which the corrective parameter is to be taken into account in the manufacture of the aligner.

Advantageously, the step of generating a corrective 3D model is carried out based on the corrective parameters and diagnostic factors previously determined. This combination of elements makes it possible to address all the issues and to define a corrective 3D model, representing an ideal objective for the patient's oral system.

Even more advantageously, parameters such as the patient's age, the patient's dental age, the patient's growth stage, the presence of inborn or acquired morphological malformations, or the presence of genetic diseases can be taken into account in the process of determining said 3D model.

Advantageously, when the computing unit identifies the need to use a plurality of corrective dental aligners to transform the initial 3D model into the corrective 3D model, the computing unit generates a succession of intermediate 3D models, in the same number as the number of corrective dental aligners so that the last model generated corresponds to said corrective 3D model and so that each intermediate model defines an intermediate corrective model.

In an alternative embodiment, the 3D model can be used to generate a mold of the corrective aligner, which is also considered a negative of the aligner. This mold, or negative, represents the complementary shape to the desired corrective aligner. It is used to create a mold wherein the biocompatible material will be introduced to form the corrective aligner.

Advantageously, the creation of a mold from the 3D model makes it possible to obtain custom-made aligners with a high degree of precision, respecting the dimensions and specific details of the patient's dentition. This method offers flexibility in the production of corrective aligners tailored to individual patient needs.

In practice, the choice of using a 3D model to generate an aligner mold, or an aligner negative, will depend on the specific requirements of the treatment, the materials used and the practitioner's preferences. Their implementation enables the manufacturing method to be optimized according to technical constraints and desired therapeutic objectives.

Advantageously, the step of manufacturing a corrective dental aligner from said 3D model makes it possible to obtain a dental aligner whose shape is designed to address all of the previously identified functional, orthopedic and orthodontic diagnostic factors.

Also advantageously, when the computing unit identifies the need to use a plurality of corrective dental aligners to transform the initial 3D model into the corrective 3D model, the manufacturing step generates as many corrective dental aligners as intermediate 3D models, so that each corrective dental aligner takes into account at least some of the previously determined corrective parameters and so that the corrective elements present on any one of the aligners is determined based on the temporality index associated with each of said corrective parameters.

In the present invention, “3D model of a patient's oral system” means a three-dimensional digital depiction of all the teeth, gums, underlying bone and tissue structures of the patient's oral cavity, obtained from digitization data such as intraoral scans, photographs, magnetic resonance imaging, CT imaging or any combination of these techniques.

In the present invention, a patient's “oral system” refers to the complex set of structures that make up said patient's oral cavity and dentition; including in particular:
a) soft tissues such as the gums, tongue and oral mucosa covering the inner walls of the mouth;
b) the bony base, in particular the upper and lower maxillae, dental alveoli and bony palate; and
c) the teeth and their various parts, such as roots, dentin and dental pulp.

In the present invention, “diagnostic factors” refer to a set of patient anatomical conditions recognized as functional, orthodontic and orthopedic dysfunctions.

The diagnostic factors used to determine the corrective factors necessary for the patient's oral system are determined based on the patient's dentofacial anatomy, muscular and skeletal structures and age, and in particular their dentition, as well as individual needs and appropriate treatments for the design of the customized corrective dental aligner, which then serves as the basis for determining the necessary corrective parameters of the patient's oral system.

In a cumulative embodiment of the invention, the step of receiving a 3D model of the patient's oral system is preceded by a step of providing at least one dentofacial image of the patient and a step of generating a 3D model of the patient's oral system from said dentofacial image.

Advantageously, the dentofacial image can be obtained by imaging techniques such as panoramic radiography, cone scanner, magnetic resonance imaging, digital volume tomography, 3D photogrammetry or any combination of two or more of said imaging techniques.

In this way, the computer system can generate a 3D model of the patient's oral system from the dentofacial image provided, enabling a diagnostic assessment of the patient's initial situation by determining functional, orthopedic and orthodontic diagnostic factors.

Advantageously, the step of generating a 3D model of the patient's oral system from the dentofacial image provided may involve using algorithms for the three-dimensional geometric reconstruction of structures from two-dimensional images, and in particular algorithms for the volumetric reconstruction of meshes, as well as post-processing algorithms for correcting errors in 3D meshes and/or improving resolution by eliminating artifacts, smoothing surfaces and/or reducing the number of elements making up the mesh.

In a cumulative embodiment of the invention, the at least one dentofacial image is obtained from dental impressions or three-dimensional images of the patient's oral system.

In this way, the use of dental impressions and/or three-dimensional images of the patient's oral system enables a 3D model of the patient's oral system to be generated with high fidelity, thereby increasing the final resolution of the model and allowing fine details of the patient's oral system to be captured that might not be taken into account if the 3D model were generated from two-dimensional images alone.

In a cumulative embodiment of the invention, the step of generating at least one 3D model of a customized corrective aligner comprises generating a sequence of 3D models, established on the expected evolution of the patient's morphology during treatment, and enabling the initial model to be progressively transformed into the corrective model; and in that it comprises a sequence of steps for manufacturing a corrective aligner from each of the 3D models of said sequence of 3D models.

Advantageously, generating a sequence of 3D models associated with said sequence of steps for manufacturing a corrective aligner makes it possible to progressively correct functional, orthopedic and orthodontic defects as identified in the step of determining diagnostic factors, and to ensure the progressive modification of the patient's dental and maxillofacial anatomy so as to improve the speed and effectiveness of treatment while minimizing patient discomfort. In addition, this allows expected progress during treatment to be taken into account, enabling certain elements of the aligner to be rearranged, in particular initial corrective elements that may no longer be required at a later stage of treatment or may have to be introduced following a prior modification of the patient's anatomy. For example, a lingual re-education element may be provided on the first corrective aligner, but not on subsequent aligners; similarly, a tooth growth guidance element may only be integrated into the aligner following palatal expansion to widen the dental arch and palate, thereby making the presence of said guidance element in the aligner conditional on a later stage.

Even more advantageously, compared with conventional aligners, the customized corrective aligner developed owing to this invention reduces the number of aligners required in the treatment sequence. Owing to extensive customization and consideration of orthodontic, functional and orthopedic factors, these aligners are designed to offer more effective, targeted treatment.

In this way, patients can benefit from faster progress toward the desired tooth alignment, reducing the total number of aligners required during treatment. This means faster treatment, lower costs and greater patient comfort.

In an alternative or cumulative embodiment of the invention, the corrective aligner is made from an elastic material.

Advantageously, the use of an elastic material offers increased patient comfort and maximizes the adaptation of the aligner to the patient's anatomy.

In a further alternative or cumulative embodiment of the invention, the corrective aligner is also made from a biocompatible and resistant material.

Advantageously, the choice of a biocompatible material ensures good tolerance by the patient's body, limiting the risks of allergy and irritation. The strength of the material ensures the aligner's durability and effectiveness throughout orthodontic treatment.

Advantageously, the use of a biocompatible material ensures that the aligner is well tolerated by the patient's oral tissues, reducing the risk of allergic reactions or irritation and improving patient comfort and treatment safety. Additionally, the increased strength of the biocompatible material ensures the durability of the corrective dental aligner over time, enabling the aligner to withstand daily wear and tear and to preserve its shape and function despite the mechanical stresses experienced when the aligner is worn by the patient.

If desired, the corrective aligner can be made, in whole or in part, from a biocompatible material such as elastomers, ethylene vinyl acetate, glycolized polyethylene terephthalate, thermoplastic polyurethane, 3D printing resins, silicone, polyetheretherketone, or any combination obtained from said materials.

In one embodiment of the invention, the corrective aligner is made from a colored or dyeable material. Advantageously, this dyeing makes it possible to personalize the aligner to the patient's taste, thereby encouraging the wearing of the corrective aligner and improving the success of the treatment.

If desired, the corrective aligner can be made of a translucent material or have areas that are substantially translucent, colored or fully transparent.

Alternatively, the corrective dental aligner can be made of an opaque material or have substantially opaque, colored or colorable areas.

In an alternative or cumulative embodiment of the invention, the corrective aligner has decorative elements such as color patterns, texture patterns or relief or etching patterns.

Advantageously, the presence of such decorative elements enables complete personalization for the patient, so as to encourage them to wear the product appropriately for successful treatment, for example, embossing the patient's name or a decorative embossed element such as an animal or a symbol chosen by the patient.

Even more advantageously, the raised embossed element could be a QR code, which could contain treatment-specific information, such as the practitioner's contact details, instructions for using and maintaining the aligner, or treatment monitoring and control information. This QR code would enable the patient, as well as healthcare professionals involved in monitoring treatment, to access relevant information easily, improving communication and treatment follow-up. What is more, the use of a QR code offers a discreet solution for including important information without compromising the aesthetics of the aligner.

In a cumulative embodiment of the invention, the aligner manufacturing step is implemented by an aligner additive manufacturing method from the 3D model of the customized corrective aligner.

Advantageously, manufacturing the corrective aligner using an additive manufacturing method ensures that it is optimally adapted to the patient's anatomy, in particular by adjusting exactly to the characteristics of the patient's oral system. In addition, the use of an additive manufacturing method reduces the time and cost of manufacturing the corrective aligner.

In a cumulative embodiment of the invention, the additive manufacturing method is a resin and/or silicone 3D printing method.

Advantageously, 3D printing in resin and/or silicone makes it possible, owing to their mechanical properties, to produce corrective dental aligners of complex shape while offering good durability over time, resulting in a more comfortable, more aesthetic treatment that is better adapted to the patient's individual requirements and that facilitates the dental professional's work.

Even more advantageously, due to their elastic and flexible nature, silicone aligners offer a particularly soft and pleasant wearing experience for the patient, reducing potential irritation and discomfort and improving patient adherence to treatment.

In a cumulative embodiment of the invention, the aligner manufacturing step is implemented by a method for resin and/or silicone molding of the aligner from the 3D model of the customized corrective aligner.

Advantageously, the molding method enables the complex details of the 3D model to be faithfully reproduced, thus ensuring that the corrective aligner is optimally fitted to the patient's oral system. What is more, the molding method is also faster and less costly than conventional methods of manufacturing dental aligners, such as manual assembly of metal and resin-based structures by the dental professional.

In an alternative or cumulative embodiment of the invention, the step of generating at least one 3D model of a customized corrective aligner involves adding corrective elements to said 3D model that can subsequently be removed from the 3D model.

Advantageously, the addition of corrective elements that can later be removed from said 3D model enables correct planning of the treatment steps, at the same time facilitating the fitting of the corrective aligner according to the expected evolution of the patient's oral system.

Corrective elements that can later be removed from the 3D model of the customized corrective aligner in particular include dental wedges to create space between teeth, orthodontic buttons to facilitate tooth traction, elastics to correct malocclusions, mini-screws to facilitate tooth movement, and elements to correct tooth position and improve dental occlusion. The addition of these corrective elements makes it possible to anticipate the various stages of dental treatment and to plan the adjustment of the corrective aligner according to the expected evolution of the patient's oral system. In this way, the invention offers customized, optimized dental treatment for each patient, while simplifying the method of manufacturing and fitting the corrective aligner.

In a cumulative embodiment of the invention, the step of generating at least one 3D model of a customized corrective aligner involves adding retention elements to said 3D model to improve the effectiveness of the aligner.

Retention elements in particular include fasteners, hooks, aligner-side retention elements, wing-shaped fasteners, or special retention elements such as composite resin buttons or metal fasteners. Advantageously, the retention elements are designed to ensure better transmission of the corrective forces induced by the aligner, thus helping to improve the overall effectiveness of the treatment. Retention elements are added individually for each patient, based on tooth morphology and specific treatment needs.

In a cumulative embodiment of the invention, the step of generating at least one 3D model of a customized corrective aligner involves adding elements designed to correct dental and/or bone malpositions to said 3D model.

Advantageously, the elements designed to correct dental and/or bone malpositions enable the corrective aligner to be precisely and individually adapted based on the patient's specific needs, while minimizing the risk of complications due to an ill-fitting aligner.

Orthodontic braces, dental aligners, orthodontic wires, dilators, Herbst rods, molar elevators, planar tracks, intermaxillary elastics, springs, palatal expanders, palatal plates, including screw, butterfly, Hawley, Stephenson and Fouet plates, with or without fins, are all used to correct dental and/or bone malposition.

In an alternative or cumulative embodiment of the invention, the step of generating at least one 3D model of a customized corrective aligner involves adding hooking elements for auxiliary elements, such as elastics or springs.

Advantageously, the incorporation of said hooking elements for auxiliary elements on the 3D model of the corrective aligner makes it possible to take direct account of the dimensions and mechanical constraints of said hooking elements and/or to simulate their impact on the patient's oral cavity on the computer.

In an alternative or cumulative embodiment of the invention, the corrective dental aligner is geometrically designed to retrain the patient's jaw muscles and support structures.

Advantageously, the geometric design of the aligner can be chosen to improve jaw function and tooth position, facilitating long-term oral hygiene by creating a healthier oral environment.

Also advantageously, the customized corrective aligner improves the patient's quality of life, in particular by facilitating better breathing and having a positive impact on the growth and development of the future adult. By correcting dental misalignments and bite problems, the aligner can help restore dental alignment and a healthy jaw, contributing to easier breathing and better upper airway function.

What is more, by correcting orthodontic problems in children and adolescents, the customized aligner can have a beneficial effect on facial growth and development, thus preventing future problems with the jaw, teeth and facial muscles. This can lead to improved facial aesthetics and masticatory function, contributing to better quality of life and self-confidence in the future adult.

In an alternative or cumulative embodiment of the invention, the aligner may comprise elements for measuring the patient's wearing time, in particular integrated sensors such as accelerometers, temperature sensors and/or pressure sensors and/or color markers or fatigue indicators.

Advantageously, these wear sensors can detect when the aligner is inserted into the patient's mouth and record the length of time it is worn. In addition, wear indicators, such as colored markers or fatigue indicators, can be used to help the patient and the dental professional monitor the progress of treatment and check compliance in terms of wearing the aligner.

Advantageously, the aligner can comprise magnetic elements, directed so as to exert a force in a given direction and with a pre-selected intensity, thus enabling targeted and precise action on the desired anatomical parts. Said magnetic elements can be magnets, in particular made of neodymium, which offer a strong magnetic force despite their small size. These magnets can be placed inside the aligner, in specific locations corresponding to the areas of the dentition to be treated, or attached to complementary dental accessories, such as orthodontic braces, to enhance the effectiveness of the aligner.

The invention also relates to a customized corrective dental aligner for correcting a patient's oral system, manufactured using the manufacturing method disclosed above.

Advantageously, by opting for a corrective dental aligner rather than a fixed dental device, the patient benefits from superior comfort without sacrificing treatment effectiveness. Due to its high efficiency, the dental aligner can enable reduced wear compared to traditional fixed braces, contributing to a better overall experience for the patient while ensuring successful orthodontic treatment. As a result, the corrective dental aligner is worn mainly at night and for a few hours, particularly two hours, during the day.

If desired, graphic markings such as drawings, logos, signs, symbols or text can be integrated into the corrective dental aligner owing to the manufacturing method used.

Advantageously, the graphic markings enable advanced personalization, contributing to the insertion of the manufacturer's brand and/or the addition of decorative graphics to provide increased motivation for the patient to wear the corrective dental aligner, particularly in the case of children.

The invention also relates to a computer system for manufacturing a customized corrective dental aligner, comprising a computing unit arranged to implement the method according to the invention.

Preferably, the computer system comprises a system for additive manufacturing of dental aligners, in particular a 3D printer.

The invention also relates to a computer program, stored on a data carrier, and comprising program code which is designed to, when executed by a computer, implement the steps of receiving, determining functional, orthopedic and orthodontic diagnostic factors, determining the set of corrective parameters and generating the corrective 3D model of the previously disclosed method for manufacturing a customized corrective aligner.

The invention also relates to a data carrier whereupon the computer program comprising program code is recorded which is designed to, when executed by a computer according to a previously disclosed embodiment of the invention.

### BRIEF DESCRIPTION OF THE FIGURES

Other advantages and features of the present invention are now described with the aid of an example that is purely illustrative and in no way limiting as to the scope of the invention, and based on the attached drawings, wherein the various figures represent:

FIG. 1 schematically and partially shows a block diagram of a method of making a corrective dental aligner according to one embodiment of the invention.

FIG. 2 shows, schematically and partially, a computer system for manufacturing customized corrective dental aligners, connected to a system for additive manufacturing of dental aligners according to one embodiment of the invention.

FIG. 3 shows, schematically and partially, a graphical interface for analyzing 2D and/or 3D images and for analyzing, generating and visualizing 3D models of a patient's oral system according to one embodiment of the invention.

FIG. 4 shows, schematically and partially, an initial 3D model and a corrective 3D model of a patient's oral system.

FIG. 5 shows, schematically and partially, a 3D model of a customized corrective dental aligner manufactured from a corrective 3D model of a patient's oral system according to one embodiment of the invention.

FIG. 6 shows, schematically and partially, a customized corrective dental aligner manufactured using the dental aligner manufacturing method according to one embodiment of the invention.

In the following description, identical elements, by structure or function, appearing in different figures retain, unless otherwise specified, the same references.

### DESCRIPTION OF THE EMBODIMENTS

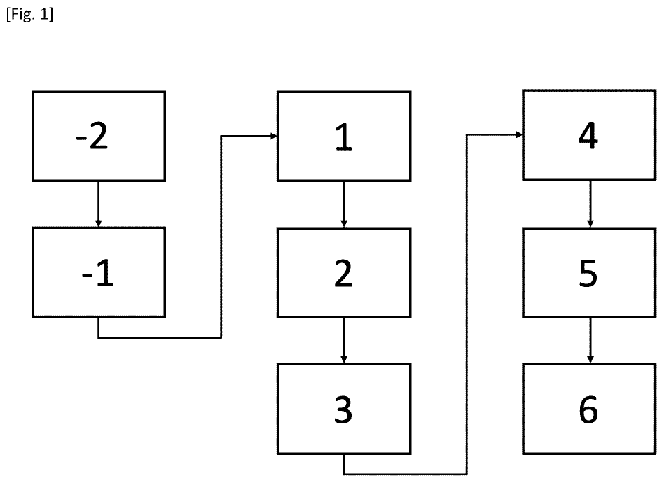

FIG. 1 shows a method for manufacturing a personalized corrective dental aligner 30 for correcting a patient's oral system, the method being implemented by a computer system 10.

The method comprises a first step-2 of providing a first dentofacial image 19, in this case a radiograph, and a second three-dimensional image of the patient's oral system (not shown).

The method then comprises a step-1 of generating an initial 3D model of the patient's oral system 20 from the radiograph 19 and the three-dimensional image of the patient's oral system.

The method then comprises a step 1 wherein the computer system receives the 3D model of the patient's oral system 20.

The method then comprises a step 2 of determining functional, orthopedic and orthodontic diagnostic factors 101 of the patient's oral system.

The determination of said factors is performed by the computing unit 11 of the computer system 10 and is based on a set of measurements and calculations on anatomical parameters derived from the initial 3D model 20 and analyses performed on the radiographic 19 and three-dimensional images of the patient's oral system.

The method then comprises a step 3 of determining a set of corrective parameters of the patient's oral system from said previously determined diagnostic factors 101.

The method then comprises a step 4 of generating a corrective 3D model 21 from the initial model 20, the corrective parameters and the diagnostic factors.

The method then comprises a step 5 of generating a 3D model of a customized corrective dental aligner 22, enabling the initial model 20 to be transformed into the corrective model 21

The method comprises a final step 6 of manufacturing a corrective aligner 30 from the 3D model of a customized corrective dental aligner 22.

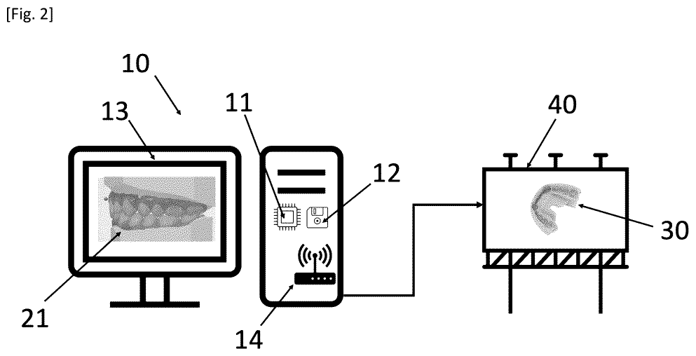

FIG. 2 shows a computer system for manufacturing customized corrective dental aligners 30, connected to a system 40 for additive manufacturing of dental aligners. The computer system comprises a computing unit 11, a storage memory (not shown) containing a radiograph 19, a three-dimensional image of the patient's oral system and a 3D model of the patient's oral system. The computer system 10 also comprises a digital terminal for controlling the computing unit 11 by means of a graphical interface 13 and for accessing the storage memory so that the contents of said storage memory can be duplicated, deleted, transmitted and modified.

The computer system 10 comprises a communication device 14 connected to the Internet for controlling the dental aligner manufacturing system 40. The dental aligner manufacturing system 40 is a 3D printing system for dental aligners 30 made of biocompatible silicone substantially similar in color to the patient's teeth.

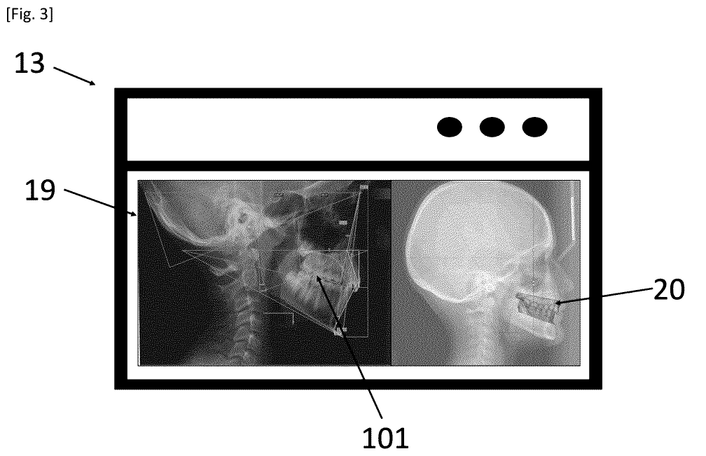

FIG. 3 shows the details of the graphical interface 13 at a given moment of use. The radiographic image 19 of the patient is visualized, along with a set of measurement lines and angles 101 for determining the patient's functional, orthopedic and orthodontic diagnostic factors.

The graphical interface 13 also has a second viewing window where a dynamic visualization of the 3D model of the patient's oral system 20 is superimposed on the radiographic image 19.

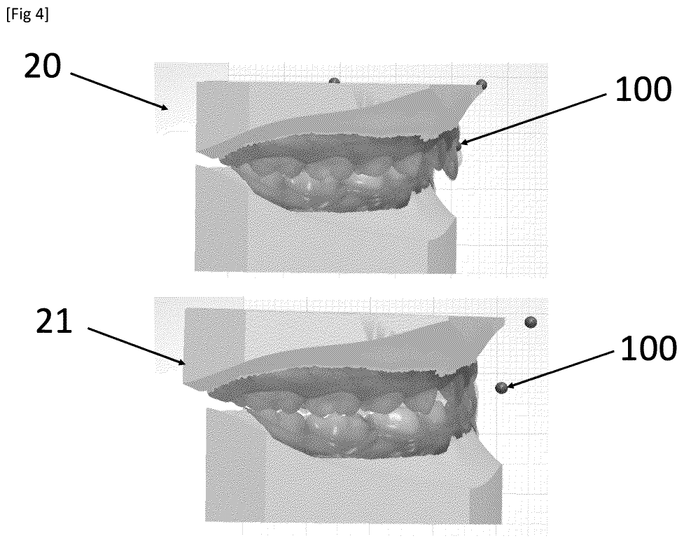

The initial 3D model 20 of the patient's oral system and the corrective 3D model 21 of the patient are shown in [FIG. 4]. Point 100 is a reference point, providing visual support and enabling changes in the patient's oral system to be distinguished between the two models. The initial model 20 shows a misalignment of the upper jaw with respect to the lower jaw, which has been automatically corrected in the corrective model 21.

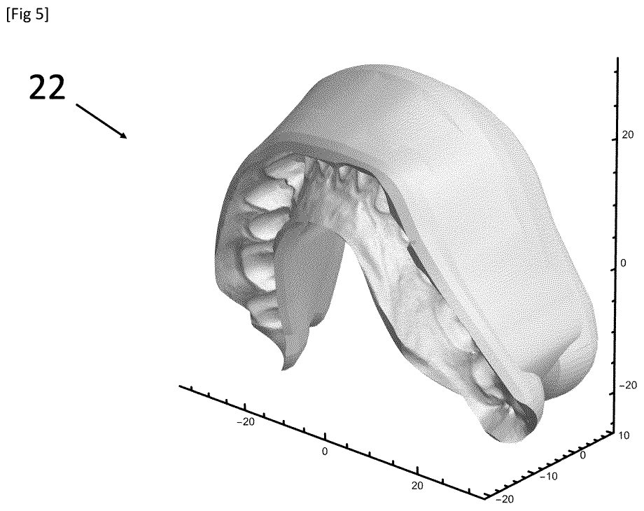

FIG. 5 shows a 3D model of a customized corrective dental aligner 22 obtained by the manufacturing method, enabling the initial 3D model 20 to be transformed into the corrective 3D model 21. The customized corrective dental aligner 22 is substantially similar in color to the patient's teeth and is made of biocompatible silicone using a silicone 3D printing method.

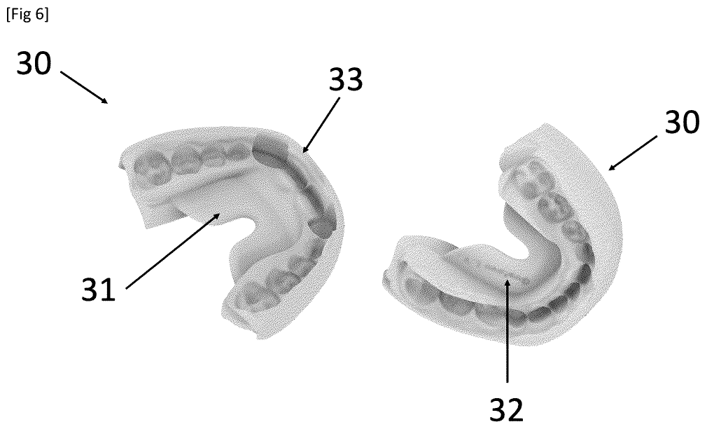

A corrective dental aligner 30 is shown in [FIG. 6] from two different angles. In step 3 of determining the corrective parameters of the patient's oral system, it was determined that a corrective parameter for tongue position should be introduced. By taking into account the different types of expectations according to dental age, such as the specific needs related to milk teeth and future permanent teeth, appropriate adjustments have been made to the design of the aligner. Based on this information, a corrective element 31 was designed, leading to the presence of said corrective element both on the 3D model of the aligner 22 and on the customized corrective aligner 30.

The corrective aligner 30 is made of an opaque light-grey material.

The corrective aligner 30 also has a graphic element 32 for personalization, corresponding to the patient's name.

The foregoing description clearly explains how the invention achieves its objectives, namely to propose a method for manufacturing a customized corrective dental aligner for a patient which jointly integrates the results of a set of automated functional, orthodontic and orthopedic analyses of the patient's oral system, in order to simultaneously correct functional, orthopedic and orthodontic problems. This method is based on the creation of a 3D model specific to each patient, enabling us to design an aligner that is perfectly adapted to the patient's age, dental morphology and orthodontic and orthopedic needs.

In any case, the invention is not limited to the embodiments specifically described in this document, and extends in particular to any equivalent means and to any technically operative combination of these means. In particular, it will be possible to envisage other ways of making the corrective dental aligner, using different materials or using different manufacturing techniques from those previously disclosed. In particular, more advanced 3D modeling techniques or more recent 3D printing technologies could be used. Additionally, the invention can be adapted to other dental or medical applications, such as the manufacture of dental prostheses, the manufacture of customized dental implants, or the creation of medical devices for other parts of the body.

1. A method for manufacturing a personalized corrective dental aligner (30) for correcting a patient's oral system, the method being implemented by a computer system (10), characterized in that it comprises the following steps:
a. a step (1) wherein the computer system receives at least one 3D model (20), known as the initial model, of the patient's oral system.
b. a step (2) for determining functional, orthopedic and orthodontic diagnostic factors of the patient's oral system;
c. a step (3) of determining a set of corrective parameters of the patient's oral system from said diagnostic factors;
d. a step (4) of generating a 3D model (21), known as a corrective model, from the initial model (20), said corrective parameters and said diagnostic factors;
e. a step (5) of generating at least one 3D model (22) of a customized corrective aligner, enabling the initial model (20) to be transformed into the corrective model (21);
f. a step (6) of manufacturing a corrective aligner (30) from said 3D model of a customized dental aligner.

2. The method according to claim, characterized in that said step for determining functional, orthopedic and orthodontic diagnostic factors of the patient's oral system comprises:
a. determining functional diagnostic factors relating to the patient's lingual postures, ventilation, mastication, swallowing, speech and salivation, orofacial muscle tone, labial competence, coordination of tongue movements, presence of labiolingual malpositions, presence of joint and/or muscle pain, and presence of tissue and musculoskeletal malformations;
b. determining orthopedic diagnostic factors relative to the geometric and structural relationships between the upper and lower dental arches, the coordination of jaw movements, the resting position of the mandible and the presence of skeletal imbalances;
c. determining orthodontic diagnostic factors relative to tooth location and alignment, tooth inclination and rotation, interdental space size, the presence of crowding or overlapping teeth, the presence of dental arch contractions or dental arch expansions, missing teeth, occlusal balance and the presence of anomalies in tooth shape and size

3. The method according to claim 1 or 2, characterized in that the step of receiving a 3D model (20) of the patient's oral system is preceded by a step (2) of providing at least one dentofacial image (19) of the patient and a step (1) of generating a 3D model (20) of the patient's oral system from said dentofacial image (19).

4. The method according to claim 3, characterized in that said at least one dentofacial image (19) is obtained from dental impressions or three-dimensional images of the patient's oral system.

5. The method according to one of claims 1 to 4, characterized in that the step of generating at least one 3D model of a customized corrective aligner (22) comprises generating a sequence of 3D models enabling the initial model (20) to be progressively transformed into the corrective model (21); and in that it comprises a sequence of steps for manufacturing a corrective aligner from each of the 3D models of said sequence of 3D models.

6. The method according to one of claims 1 to 5, characterized in that step 6 of manufacturing the corrective dental aligner (30) is implemented by an aligner additive manufacturing method from the 3D model (22) of the customized corrective aligner.

7. The method according to one of claims 1 to 6, characterized in that step 6 of manufacturing the aligner is implemented by a method for resin and/or silicone molding of the aligner from the 3D model (22) of the customized corrective dental aligner.

8. The method according to one of claims 1 to 7, characterized in that the step of generating at least one 3D model (22) of a customized corrective dental aligner involves adding elements designed to correct dental and/or bone malpositions to said 3D model.

9. A customized corrective dental aligner (30) for correcting a patient's oral system, characterized in that it is manufactured by means of the method according to one of the preceding claims.

10. A computer system for manufacturing a customized corrective dental aligner, comprising a computing unit arranged to implement the method according to one of claims 1 to 9.

11. A computer program product, recorded on a data carrier (12), and comprising program code which is adapted, when executed by a computer, to implement the method of one of claims 1 to 9.

12. A data carrier (12) whereupon the computer program according to the preceding claim is recorded.
